(19) United States
(12) Patent Application Publication
(10) Pub. No.: US 2013/0060701 A1
(43) Pub. Date: Mar. 7, 2013

(54) ELECTRONIC PAYMENT SERVICE METHOD, AND ELECTRONIC PAYMENT SERVICE APPARATUS, MOBILE COMMUNICATION TERMINAL, AND TRANSACTION TERMINAL FOR PERFORMING THE METHOD

(71) Applicants: Yong Seok Moon, Seoul (KR); Chang Hwa Lyou, Seoul (KR)

(72) Inventors: Yong Seok Moon, Seoul (KR); Chang Hwa Lyou, Seoul (KR)

(73) Assignee: Chang Hwa LYOU, Seoul (KR)

(21) Appl. No.: 13/696,596

(22) PCT Filed: Apr. 20, 2011
(86) PCT No.: PCT/KR2011/002844

§ 371 Date: Nov. 6, 2012

(30) Foreign Application Priority Data
May 6, 2010 (KR) 10-2010-0042337
Jul. 8, 2010 (KR) 10-2010-0066029
Mar. 14, 2011 (KR) 10-2011-0022540

(51) Int. Cl. G06Q 40/00

(52) U.S. Cl. 705/44

(57) ABSTRACT

The present invention relates to a payment apparatus and payment method using a mobile communication network. According to one embodiment of the present invention, the electronic payment service apparatus, which carries out payment using a mobile communication network, comprises: a transaction authentication unit which receives article purchase information from a transaction terminal and authenticates the transaction terminal; a transaction identification number information generating unit which generates transaction identification number information corresponding to the article purchase information received from the transaction terminal; and a payment authentication information generating unit which transmits the transaction identification number information to the transaction terminal, receives payment information corresponding to the transaction identification number information from a mobile communication terminal, and generates payment authentication information corresponding to the payment information.

### TECHNICAL FIELD

The present invention relates to an electronic payment service method and an electronic payment service apparatus, a mobile communication terminal and a transaction terminal for performing the method.

### BACKGROUND ART

As a user purchases a certain goods and pays for the goods in cash or using a credit card in a conventional art. When the user pays using a credit card, the user gives the credit card to a clerk of a contracted-shop, and the clerk makes recognition from a transaction terminal and then finishes the payment. After the payment is finished, the clerk returns back the credit card to the user. For the payment for a certain goods, the above mentioned complicated procedures are necessitated.

For the above mentioned payments, the user should always carry all kinds of the cards such as a credit card, a check card, a cash-loaded card, a cash card, a gift card, a point card, etc. The above mentioned card contains a users information such as a card serial number. If the user pays using a card or loses the card, the users information might be open to others.

### DISCLOSURE OF INVENTION

Accordingly, it is an object of the present invention to provide a method for performing a payment using a mobile communication network when paying for a certain goods after a user purchases it and a payment service apparatus for performing the method.

The present invention provides a credit card for the sake of a payment and a payment apparatus for performing a users transaction authorization.

The present invention provides a payment apparatus which makes it possible to protect a users personal information because it is not needed to give a certain payment means such as a credit card to a clerk of a contracted-shop when a user pays for a certain goods.

The present invention provides a payment apparatus which makes it possible to protect a users personal information and to use in safe an internet commercial transaction because a user does not need to input a personal credit information such as a credit card serial number into a computer when a user purchases a certain goods on the internet.

The present invention provides a payment apparatus which can prevent an illegal copy and use of a payment means because a payment means does not get lost.

The present invention provides a payment apparatus which has a good portability because multiple payment means are stored in a mobile communication terminal.

The present invention provides a payment apparatus which makes it possible to pay even when a mobile communication terminal having a payment function via a transaction terminal is not positioned in the same place.

The present invention provides a payment apparatus in which an end to end security can be obtained by way of an asymmetrical key cording way with respect to all data which are transferred between a mobile communication terminal and a financial service apparatus.

To achieve the above objects, there is provided an electronic payment service apparatus for performing a payment using a mobile communication network.

According to an embodiment of the present invention, an electronic payment service apparatus performing a payment using a mobile communication network comprises a transaction authorization part which receives a transaction purchase information from a transaction terminal and authorizes the transaction terminal; a transaction identification number information generation part which generates a transaction identification number information corresponding to the transaction purchase information received from the transaction terminal; and a payment authorization information generation part which transmits the transaction identification number information to the transaction terminal and receives a payment information corresponding to the transaction identification number information from the mobile communication terminal and generates a payment authorization information corresponding to the payment information.

According to another aspect of the present invention, there is provided an electronic payment service method performing a payment using a mobile communication network in an electronic payment service apparatus.

According to an embodiment of the present invention, an electronic payment service method performing a payment using a mobile communication network in an electronic payment service apparatus comprises a step in which a transaction purchase information is received from a transaction terminal, and the transaction terminal is authorized; a step in which a transaction identification number information corresponding to the transaction purchase information received from the transaction terminal is generated; a step in which the transaction identification number information is transmitted to the transaction terminal, and the transaction identification number information is received from the mobile communication terminal; a step in which at least one between the transaction purchase information corresponding to the transaction identification number information received from the mobile communication terminal and an auxiliary payment information is transmitted to the mobile communication terminal; a step in which the auxiliary payment information is an information on the auxiliary payment including a discount service or point service corresponding to the transaction terminal; and a step in which a payment information including at least one among the transaction identification number information, a payment means information and an auxiliary payment means information is received from the mobile communication terminal.

According to one aspect of the present invention, there is provided a mobile communication terminal executing an electronic payment service apparatus and an electronic payment service method.

According to an embodiment of the present invention, a mobile communication terminal executing an electronic payment service apparatus and an electronic payment service method comprises an input part for inputting a transaction identification number information into the transaction purchase information; a communication part for transmitting the transaction identification number information to the electronic payment service apparatus and receiving a payment purchase information from the electronic payment service apparatus; a generation part for generating a payment information including at least one between the payment means corresponding to the payment purchase information and the auxiliary payment means; and a control part for executing a payment application for generating the payment information.

According to another aspect of the present invention, there is provided an electronic payment service method executed on an electronic payment service apparatus in a mobile communication terminal.

According to an embodiment of the present invention, an electronic payment service method executed on an electronic payment service apparatus on a mobile communication terminal comprises a step in which a transaction identification information corresponding to a transaction purchase information is inputted; a step in which the transaction identification number information is transmitted to the electronic payment service apparatus, and the payment purchase information is received from the electronic payment service apparatus; a step in which a payment information including at least one between a payment means corresponding to the payment purchase information and an auxiliary payment means is generated and transmitted to the electronic payment service apparatus; and a step in which a payment authorization result information corresponding to the payment information is received from the electronic payment service apparatus.

According to one aspect of the present invention, there is provided a transaction terminal executing an electronic payment service method.

According to an embodiment of the present invention, a transaction terminal executing an electronic payment service comprises an input part for inputting a purchase information; a communication part for generating a transaction purchase information corresponding to the purchase information and transmitting to the electronic payment service apparatus and receiving a transaction identification number corresponding to the transaction purchase information; and an output part for outputting the transaction identification number.

According to another aspect of the present invention, there is provided an electronic payment service method executed on an electronic payment service apparatus in a transaction terminal.

According to an embodiment of the present invention, an electronic payment service method executed on an electronic payment service apparatus in a transaction terminal comprises a step for inputting a purchase information and generating a transaction purchase information corresponding to the purchase information; a step for transmitting the transaction purchase information to the electronic payment service apparatus; a step for receiving a transaction identification number corresponding to the transaction purchase information from the electronic payment service apparatus; and a step for outputting the transaction identification number.

### Advantageous Effects

According to an embodiment of the present invention, there is provided an electronic payment service apparatus which performs a transaction authorization of a credit card or a user for the sake of payment.

According to an embodiment of the present invention, a users personal information can be protected since a user does not need to give directly a payment means such as a credit card to a contracted-shop when a user pays for a certain goods.

According to an embodiment of the present invention, a users personal information can be protected and an internet commercial transaction can be performed in safe unless a users personal credit information such as a credit card number is inputted when a user purchases a certain goods on the internet.

According to an embodiment of the present invention, an illegal copy and use of a payment means can be prevented since a payment means does not get lost.

According to an embodiment of the present invention, the portability is good because multiple payment means are stored in a mobile communication terminal and are used.

According to an embodiment of the present invention, the payment can be performed even when a mobile communication terminal which has a payment function via a transaction terminal is not provided in a transaction place.

According to an embodiment of the present invention, all the data transferred between a mobile communication terminal and a financial service apparatus can be encoded on an asymmetrical key basis, thus implementing an end to end security.

### BRIEF DESCRIPTION OF DRAWINGS

FIG. 1 is a view for explaining an electronic payment service method using a mobile communication terminal according to an embodiment of the present invention.

FIG. 2 is a block diagram for explaining a mobile communication terminal according to an embodiment of the present invention.

FIG. 3 is a view for explaining an electronic payment service method using a mobile communication network in a mobile communication terminal according to an embodiment of the present invention.

FIG. 4 is a bock diagram of an electronic payment service apparatus according to an embodiment of the present invention.

FIG. 5 is a view for explaining an electronic payment service method using a mobile communication network in an electronic payment service apparatus according to the present invention.

FIG. 6 is a block diagram of a transaction terminal according to the present invention.

FIG. 7 is a view for explaining an electronic payment service method in a transaction terminal according to the present invention.

FIGS. 8 and 9 are views of the procedures for explaining an electronic payment service method using a mobile communication network according to an embodiment of the present invention.

FIGS. 10 and 11 are views of the procedures for explaining an electronic payment service method using a mobile communication network according to another embodiment of the present invention.

FIGS. 12 to 15 are views of the examples of an electronic payment service method using a mobile communication terminal according to an embodiment of the present invention.

### BEST MODES FOR CARRYING OUT THE INVENTION

The present invention might have various modifications and various embodiments, and the specific embodiments are shown in the drawings and will be explained by way of the following descriptions of the invention; however such descriptions are not intended to limit the specific embodiments, and it should be understood that such disclosures contain all changes, equivalents and alternatives belonging to the concept and technical scope of the present invention.

The payment apparatus using a mobile communication network and a payment method for performing the same according to the embodiments of the present invention will be described with reference to the accompanying drawings.

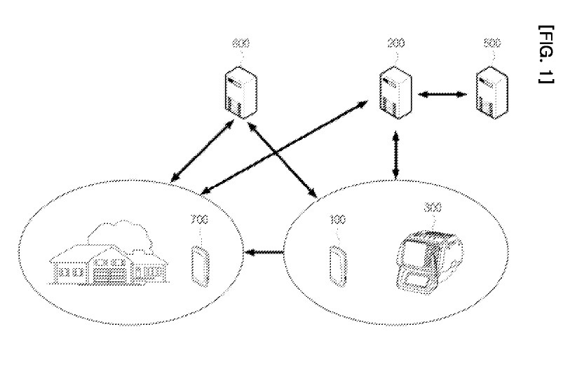

FIG. 1 is a view for explaining an electronic payment service method using a mobile communication terminal according to an embodiment of the present invention.

As shown in FIG. 1, the transaction terminal 300 helps input a purchase information on a certain goods that a purchaser wants to buy.

The transaction terminal 300 transmits the inputted transaction purchase information to an electronic payment service apparatus 200.

The electronic payment service apparatus 200 generates a transaction identification number information after a transaction is authorized using a transaction purchase information from the transaction terminal 300 and stores the transaction purchase information and the transaction identification number information in a database. In addition, the electronic payment service apparatus 200 transmits the generated transaction identification number information to the transaction terminal 300.

The transaction terminal 300 outputs a transaction identification number information received from the electronic payment service apparatus 200.

The mobile communication terminal 100 of a purchaser inputs a transaction identification number information outputted from the transaction terminal 300.

The mobile communication terminal 100 of a purchaser according to another embodiment of the present invention transmits a transaction identification number information to the mobile communication terminal 700 of a payer positioned outside the contracted-shop after the transaction identification number information outputted from the transaction terminal 300 is inputted.

In another embodiment of the present invention, the transaction terminal 300 transmits the transaction identification number information to the mobile communication terminal 700 of a payer positioned outside the contracted-shop by way of a communication network.

In other words, in another embodiment of the present invention, when a purchaser and a payer are different, the payment method of the present invention can be performed by transmitting a transaction identification number information to the payer.

Hereinafter the payment method of the present invention will be described assuming that the mobile communication terminal 100 of the purchaser and the mobile communication terminal 700 of the payer are same.

The mobile communication terminal 100 transmits the received transaction identification number information to the electronic payment service apparatus 200.

The electronic payment service apparatus 200 extracts a transaction purchase information corresponding to the transaction identification number information received from the mobile communication terminal 100 from the database.

The electronic payment service apparatus 200 transmits the extracted transaction purchase information to the mobile communication terminal 100.

The mobile communication terminal 100 confirms the transaction purchase information received from the service apparatus 200.

The mobile communication terminal 100 selects at least one between the payment means and the auxiliary payment means after the purchase information is confirmed.

The mobile communication terminal 100 selects a user authorization means for a user authorization and transmits the user authorization information to the user authorization apparatus 600.

The user authorization apparatus 600 performs a user authorization using a user authorization information received from the mobile communication terminal 100.

The user authorization apparatus 600 might be perform a user authorization as it is separated from or integrated with the electronic payment service apparatus 200 or the financial service apparatus 500.

The user authorization apparatus 600 transmits a user authorization result information after the user authorization is finished.

The mobile communication terminal 100 generates a payment information for payments after the user authorization result information is confirmed.

The mobile communication terminal 100 transmits the generated payment information to the electronic payment service apparatus 200.

The electronic payment service apparatus 200 generates a payment authorization information for the sake of a payment authorization request to the financial service apparatus 500 using the received payment information.

The electronic payment service apparatus 200 transmits the generated payment authorization information to the financial service apparatus 500.

The electronic payment service apparatus 200 might provide an electronic payment service as it is separate from or integrated with the financial service apparatus 500.

The financial service apparatus 500 confirms the received payment authorization information and performs a payment authorization.

The financial service apparatus 500 transmits a payment authorization result information which is a result of the payment authorization to the electronic payment service apparatus 200.

The electronic payment service apparatus 200 transmits a payment authorization result information received from the financial service apparatus 500 to the mobile communication terminal 100 and the transaction terminal 300.

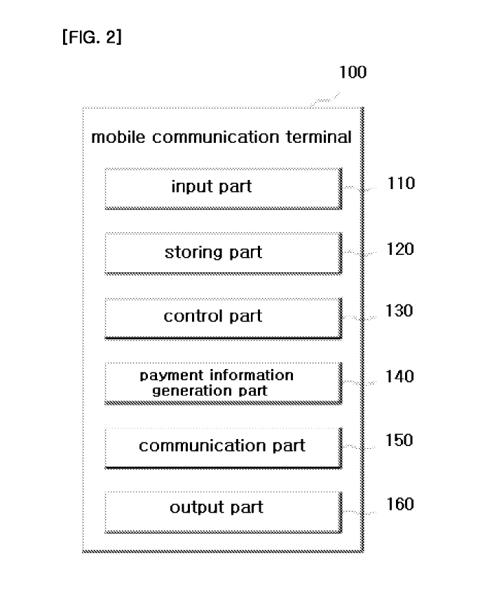

FIG. 2 is a block diagram for explaining the mobile communication terminal according to an embodiment of the present invention.

As shown in FIG. 2, the mobile communication terminal 100 comprises an input part 110, a storing part 120, a control part 130, a payment information generation part 140, a communication part 150 and an output part 160.

The mobile communication terminal 100 is a terminal which can perform by way of a mobile communication network a communication service, a payment service and a user authorization. The mobile communication terminal 100 might be a terminal which can perform a communication, a payment and a user authorization using a mobile communication network and might be formed of a cellular phone, a smart phone, a communication type navigation terminal, a laptop computer, a net book computer, a smart pad, a PDA (Portable Digital Assistant), etc.

The input part 110 performs a transaction identification information input for the mobile communication terminal 100 to perform payment.

The input part 110 can be used to input a user authorization, a payment means selection means and an auxiliary payment means selection for the mobile communication terminal 100 to perform payment.

The input part 110 performs an input for the sake of a payment application execution of the mobile communication terminal 100. The input part 110 might be formed of one among a key input method via a key pad, a touch, a button, etc., an audio input method via an audio recognition, a video input method via a barcode, a QR code and an image, and a wireless communication input method using a RF communication such as a NFC (Near Field Communication), a wifi direct, a blue tooth, a zigbee, etc. It is obvious that a certain interface apparatus in addition to the above elements can be contained.

The storing part 120 might store an information including at least one among a payment means information, an auxiliary payment means information and a user authorization means information.

Here, the payment means information might include at least one among an account information, a credit card information, a gift card information and a mobile communication rate information.

The auxiliary payment means information might contain at least among a coupon information and a point information.

The user authorization information might be one among a certificate information such as a universal user certificate, a personal user certificate, a safe click, a safe payment, etc., an IC (Integrated Circuit) information such as a SIM information, a USIM information, etc., an identification information corresponding to the mobile communication terminal 100 such as an IMSI (International Mobile Subscriber Identify), a MIN (Mobile Identity Number), a MDN (Mobile Directory Number) information, etc, and an authorization number information received from the user authorization apparatus 500, an ID information and a password information, and it is obvious that other authorization information can be also included.

In addition, the storing part 120 might be a payment application used when the mobile communication terminal 100 performs payment.

Here the payment application is an application helping perform a user authorization and a payment by selecting at least one among a payment means and an auxiliary payment means when performing a payment using the mobile communication terminal 100.

The control part 130 is configured to execute a payment application for performing payments.

The control part 130 executes a payment application stored in the storing part 120 when a payment application execution signal is inputted from the input part 110.

In addition, the control part 130 performs a control in response to the received signal when at least one selection signal corresponding to the payment means, the auxiliary payment means and the user authorization means is received from the input part 110.

The payment information generation part 140 generates a payment information for performing a payment with respect to the received transaction purchase information.

Here, the payment information is an information for the sake of a payment corresponding to the transaction purchase information that the mobile communication terminal 100 receives and might be formed of at least one among a mobile communication terminal identification information, a transaction identification number information, a user authorization information, a selected payment means information and a selected auxiliary payment means.

The communication part 150 receives a transaction purchase information from the electronic payment service apparatus 200.

In addition, the communication part 150 might receive a payment authorization result information from the electronic payment service apparatus 200.

The communication part 150 transmits a payment information with which the mobile communication terminal 100 performs a payment to the electronic payment service apparatus 200.

At this time, the communication part 150 can perform a communication with the electronic payment service apparatus 200 via a mobile communication network. Here, the mobile communication network is a communication network configured for the sake of a communication with the mobile communication terminal 100 or between the mobile communication terminal 100 and an external apparatus. It is obvious to an ordinary person skilled in the art that it contains a wireless data network such as WCDMA, GSM, 4G as well as a wireless LAN, wibro, wifi, etc.

The output part 160 outputs a payment progress or a result of the mobile communication terminal 100 to a user so that the user can recognize by way of one among a visual way, an audible way and a tactile sense way.

The output part 160 can output a payment progress or a result of the mobile communication terminal 100 in a video form by way of a 2-dimensional or 3-dimensional display.

In addition, the output part 160 can output a payment progress or a result of the mobile communication terminal 100 in an audio form by way of a guide voice.

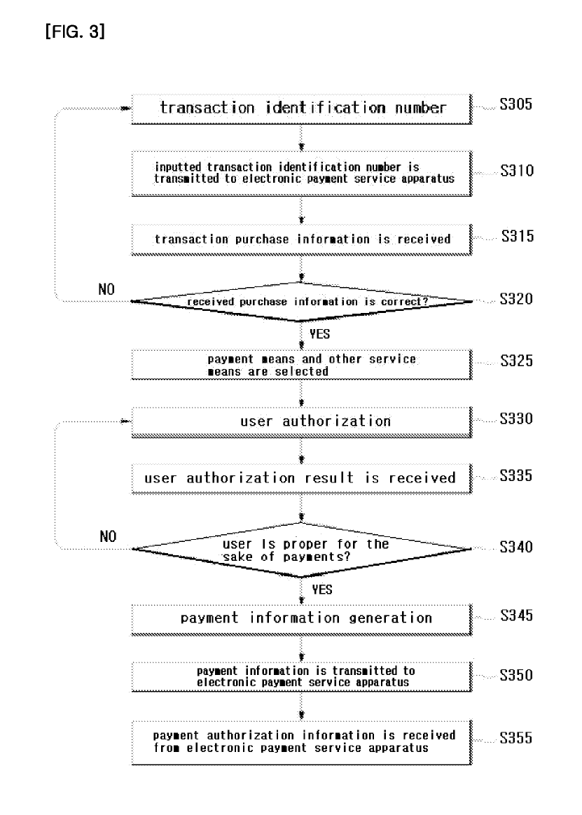

FIG. 3 is a view for explaining an electronic payment service method using a mobile communication network in a mobile communication terminal according to an embodiment of the present invention.

As shown in FIG. 3, in a step S305, the mobile communication terminal 100 receives a transaction identification information outputted from the transaction terminal 300.

The input of the transaction identification number information, as described earlier, might be one among a key input method via a key pad, a touch, a button, etc., an audio input method via an audio recognition, a video input method via a barcode, a QR code and an image, and a wireless communication input method using a RF communication such as a NFC (Near Field Communication), a wifi direct, a blue tooth, a zigbee, etc. It is obvious that a certain interface apparatus in addition to the above elements can be used.

In a step S310, the mobile communication terminal 100 transmits a transaction identification number information to the electronic payment service apparatus 200.

The mobile communication terminal 100 transmits the inputted transaction identification number information to the electronic payment service apparatus 200 via a mobile communication network.

Here, the mobile communication network is a communication network for the sake of a communication with a mobile communication terminal 100 or between a mobile communication terminal 100 and an external apparatus. It is obvious to an ordinary person skilled in the art that it contains a wireless data network such as WCDMA, GSM, 4G as well as a wireless LAN, wibro, wifi, etc

In a step S315, the mobile communication terminal 100 receives a transaction purchase information. The mobile communication terminal 100 receives a transaction purchase information corresponding to the transaction identification number information transmitted to the electronic payment service apparatus 200 by way of the mobile communication network. Here, the transaction purchase information contains at least one among a goods information to be paid for by way of the mobile communication terminal 100, a quantity information of goods, a price information of goods, a transaction terminal identification information and a contracted-shop information.

In the step S320, the mobile communication terminal 100 outputs the received transaction purchase information. The mobile communication terminal 100 outputs in such a way that the user can recognize by way of one of a visual way, an audible way or a tactile sense way so as to know whether the received purchase information matches with the purchase contents when the payment is performed.

For example, the mobile communication terminal 100 can repeat from the step S305 or can end the electronic payment service when the received transaction purchase information does not match with the purchase contents for which the payment is performed. The mobile communication terminal 100 performs the step S325 when the received transaction purchase information matches with the purchase contents for which the payment is performed.

In a step S325, the mobile communication terminal 100 selects at least one between the payment means and the auxiliary payment means.

In a step S330, the mobile communication terminal 100 performs a user authorization. The mobile communication terminal 100 performs a user authorization so as to know whether the user is proper for the payment by way of the mobile communication network. The mobile communication terminal 100 transmits the user authorization information to the user authorization apparatus using the user authorization means and performs the user authorization by receiving a result of the user authorization.

The user authorization information is as described earlier at least one among a certificate information, an IC (Integrated Circuit) information, an identification information corresponding to the mobile communication terminal 100, an authorization number information received from the user authorization apparatus 500, an ID information and a password information, and it is obvious to an ordinary person skilled in the art that all kinds of authorization information can be included.

If a plurality of user authorization means are stored in the mobile communication terminal 100, the user can selects a certain user authorization means and can perform a user authorization. Alternatively, the user authorization can be performed using a user authorization means which is previously set by means of the payment means selected for the sake of payments.

In a step S335, the mobile communication terminal 100 receives a user authorization result information. The mobile communication terminal 100 receives from the user authorization apparatus a user authorization result information based on the user authorization of the step S330.

In a step S340, the mobile communication terminal 100 confirms a user authorization result. The mobile communication terminal 100 confirms whether or not the user is proper for the sake of payments by way of a user authorization result received from the user authorization apparatus 600.

As a result of the user authorization, if the user is not proper for the sake of payments, the mobile communication terminal 100 can perform again from the step S330 or can stop the electronic payment service.

As a result of the user authorization, if the user is proper for the sake of payments, the mobile communication terminal 100 performs a step S345.

In a step S345, the mobile communication terminal 100 generates a payment information. Here, the payment information is an information for performing a payment with respect to the transaction purchase information that the mobile communication terminal 100 has received and can be at least one among a mobile communication terminal information, a transaction identification number information, a user authorization information, a selected payment means information and a selected auxiliary payment means.

In a step S350, the mobile communication terminal 100 transmits a payment information to the electronic payment service apparatus via the communication part 150. At this time, the communications of the mobile communication terminal 100 and the electronic payment service apparatus 200 for the sake of the payment information transmission are performed by way of the mobile communication network.

In a step S335, the mobile communication terminal 100 receives a payment authorization information from the electronic payment service apparatus 200. The payment authorization information is an information with respect to the payment authorization states in the financial service apparatus with respect to the payment information that the mobile communication terminal 100 has transmitted to the electronic payment service apparatus.

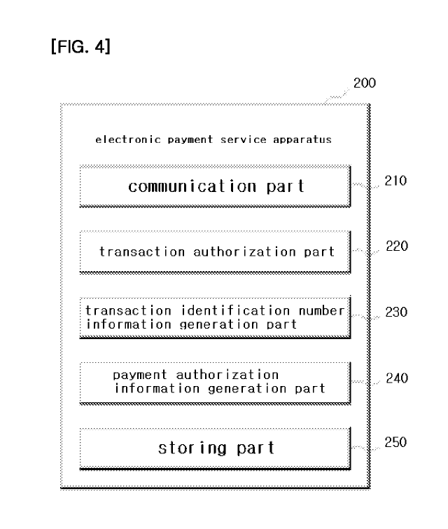

FIG. 4 is a block diagram of an electronic payment service apparatus according to an embodiment of the present invention.

As shown in FIG. 4, the electronic payment service apparatus 200 comprises a communication part 210, a transaction authorization part 220, a transaction identification number information generation part 230, a payment authorization information generation part 240 and a storing part 250.

The electronic payment service apparatus 200, for example, is an apparatus providing a payment service using at least one among an account transfer, a credit card payment, a gift card payment, a mobile communication terminal rate payment, a discount service payment, a coupon payment and a point payment. For example, an electronic payment service apparatus might be a server of a PG (Payment Gateway) company.

The communication part 210 is configured to communicate with at least one among a transaction terminal 300, a mobile communication terminal 100, a financial service relay apparatus 400 and a financial service apparatus 500.

The communication part 210 is configured to receive a transaction purchase information from the transaction terminal 300 and transfer a transaction identification information corresponding to the received transaction purchase information to the transaction terminal 300.

In addition, the communication part 210 is configured to receive a transaction identification information from the mobile communication terminal 100 and transmits a transaction purchase information corresponding to the received transaction identification information to the mobile communication terminal 100.

In addition, the communication part 210 is configured to receive a payment information from the mobile communication terminal 100 and transmit a payment authorization information corresponding to the received payment information to the financial service apparatus 500.

When a payment authorization result information corresponding to a payment authorization information is received from the financial service apparatus 500, the communication part 210 transmits the received payment authorization result information to at least one between the transaction terminal 300 and the mobile communication terminal 100.

The transaction authorization part 220 confirms whether the payment of a corresponding transaction terminal is proper by using at least one information among a transaction terminal identification information and a contracted shop information received from the communication part 210. In other words, the transaction authorization part 220 confirms whether a contracted shop has a valid contract relationship with the electronic payment service apparatus by way of authorizations.

The transaction identification number generation part 230 is configured to generate a transaction identification number information.

The transaction identification number information generation part 230 is configured to generate a transaction identification number information corresponding to a corresponding transaction purchase information by using a transaction purchase information received from the communication part 210.

Here, the transaction identification number information is generated whenever a transaction purchase information is received from the transaction terminal for the purpose of identifying the transactions. In other words, the transaction identification number information is a number which is solely generated in response to the received transaction purchase information.

The payment authorization information generation part 240 is configured to generate a payment authorization information.

When a payment information is received from the mobile communication terminal 100 via the communication part 210, the payment authorization information generation part 240 generates a payment authorization information corresponding to the received payment information. Here, the payment authorization information contains at least one among a mobile communication terminal information, a payment amount information, a user authorization information, an electronic payment service apparatus identification number, a payment means information and an auxiliary payment means information.

The storing part 250 is configured to store at least one among a transaction purchase information, a transaction identification number information and a payment authorization information.

In addition, the storing part 250 can store at least one among a discount service information which can be actually applied to each contracted shop, a coupon service information and a point service information.

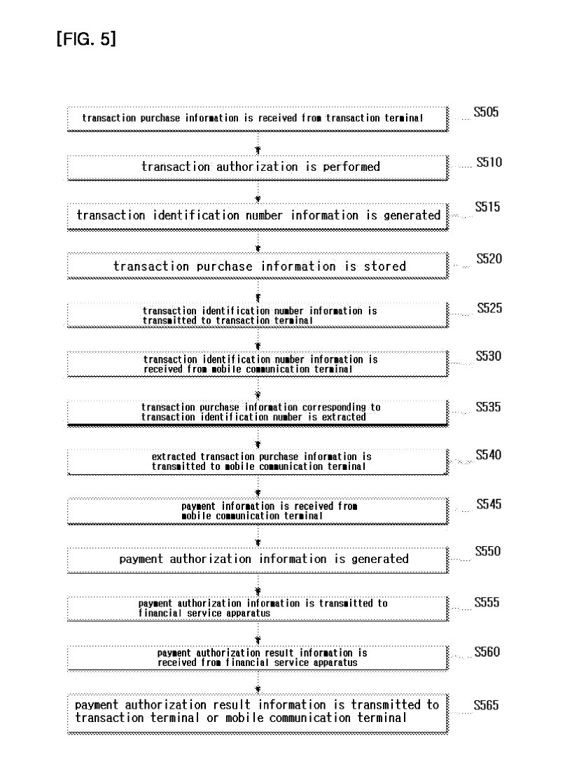

FIG. 5 is a view for explaining an electronic payment service method using a mobile communication network in an electronic payment service apparatus according to the present invention.

As shown in FIG. 5, in a step S505, the electronic payment service apparatus 200 receives a transaction purchase information from the transaction terminal 300.

In a step S510, the electronic payment service apparatus 200 performs a transaction authorization. For example, the electronic payment service apparatus 200 authorizes whether a contracted shop has a valid contracted relationship with the electronic payment service apparatus by using the received transaction purchase information.

In a step S515, the electronic payment service apparatus 200 generates a transaction identification number information. The electronic payment service apparatus 200 generates a sole transaction identification number information corresponding to the received transaction purchase information. Here, the transaction identification number information is directed to separating one transaction purchase information received from the transaction terminal from other transaction purchase information and can be formed of texts, numbers, symbols or a combination of them.

In a step S520, the electronic payment service apparatus 200 stores a transaction purchase information. The electronic payment service apparatus 200 stores a transaction purchase information from the transaction terminal 300. At this time, the electronic payment service apparatus 200 can stores a transaction identification number information corresponding to the transaction purchase information into the storing part 250 together with the transaction purchase information.

In a step S525, the electronic payment service apparatus 200 transmits a transaction identification number information to the transaction terminal 300. For example, the electronic payment service apparatus 200 transmits the generated transaction identification number information to the transaction terminal that has transmitted a corresponding transaction purchase information or the electronic payment service apparatus 200 can transmit the generated transaction identification number information to other transaction terminals requested from the transaction terminal that has transmitted the transaction purchase information.

In a step S530, the electronic payment service apparatus 200 receives a transaction identification number information from the mobile communication terminal 100.

In a step S535, the electronic payment service apparatus 200 extracts a transaction purchase information corresponding to the received transaction identification number information from the storing part 250.

In a step S540, the electronic payment service apparatus 200 transmits the extracted transaction purchase information to the mobile communication terminal 100 that has sent the transaction identification number. At this time, the electronic payment service apparatus 200 transmits the information on the auxiliary payment means which can be adapted when paying with respect to the transaction purchase information, to the mobile communication terminal 100.

In a step S545, the electronic payment service apparatus 200 receives a payment information from the mobile communication terminal 100. Here, the payment information can contain at least one among a mobile communication terminal information which will perform payments, a transaction identification number information, a user authorization means information, a selected payment means information and a selected auxiliary payment means information.

In a step S550, the electronic payment service apparatus 200 generates a payment authorization information. The electronic payment service apparatus 200 generates a payment authorization information using the payment information from the mobile communication terminal 100. The payment authorization information is an information requesting a payment authorization to the financial service apparatus 500 by using a payment information that the electronic payment service apparatus 200 has received.

In a step S555, the electronic payment service apparatus 200 transmits the generated payment authorization information to the financial service apparatus 500. The financial service apparatus 500 is a server of the financial service company which executes at least one between a payment and an auxiliary payment.

So, the financial service apparatus 500 might be a server of a company which provides a financial service such as a bank, a credit card company and a mobile communication company. The financial service apparatus 500 is selected by a payment information from the mobile communication terminal.

In a step S560, the electronic payment service apparatus 200 receives a payment authorization result information from the financial service apparatus 500. The payment authorization result information is an information with respect to a result that the financial service apparatus 500 has paid using a received payment authorization information.

In a step S565, the electronic payment service apparatus 200 transmits a payment authorization result information to at least one between the corresponding mobile communication terminal 100 and the transaction terminal 300.

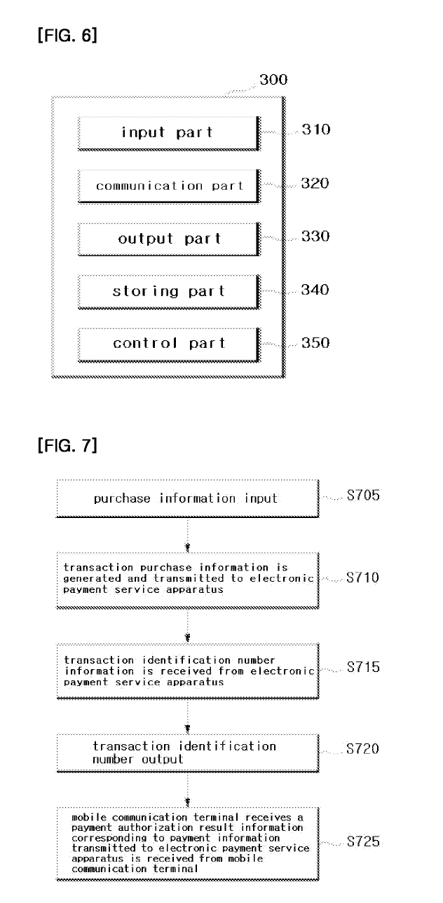

FIG. 6 is a block diagram of a transaction terminal according to an embodiment of the present invention.

As shown in FIG. 6, the transaction terminal 300 comprises an input part 310, a communication part 320, an output part 330, a storing part 340 and a control part 350.

The transaction terminal 300 is an apparatus for managing the goods data in the contracted shop and checking a sale information of a contracted shop for the sake of an inventory management and a goods management. The transaction terminal 300 could be a terminal which can perform a payment and a user authorization using a wired or wireless communication network such as a computer, a CE (Consumer Electronics) device, a cellular phone, a smart phone, a communication type navigation device, a laptop computer, a net book computer, a smart pad, a PDA (Portable Digital Assistant), etc.

A purchase information is inputted into the input part 310.

Here, the purchase information might contain at least one among a goods information which will be paid for using a transaction terminal 300, a quantity information of goods, and a price information of goods.

The communication part 320 transmits a transaction purchase information generated in response to the purchase information to the electronic payment service apparatus 200, and receives a transaction identification number information corresponding thereto.

Here, the transaction purchase information might contain at least one among an information of goods which will be paid via the transaction terminal 300, the quantity information of goods, a price information of goods, a transaction terminal identification information and a contracted shop information.

In addition, the communication part 320 receives a payment authorization result information from the electronic payment service apparatus 200.

The output part 330 outputs a transaction identification number information received from the electronic payment service apparatus 200.

The output part 330 might contain at least one among a display, a speaker, a braille output device and a local area wireless communication module which can perform either an output obtained by way of a recognition via at least one among a visible sense, an audible sense and a tactile sense or an output obtained by way of a RF signal. In addition to them, a certain interface device can be used. The local area wireless communication module might be a local area RF communication module such as a NFC (Near Field Communication), wifi direct, blue tooth, zigbee, etc.

The storing part 340 stores a purchase information, a transaction identification number information, and a payment authorization result information.

The control part 350 controls the functions of the input part 310, the communication part 320, the output part 330 and the storing part 340.

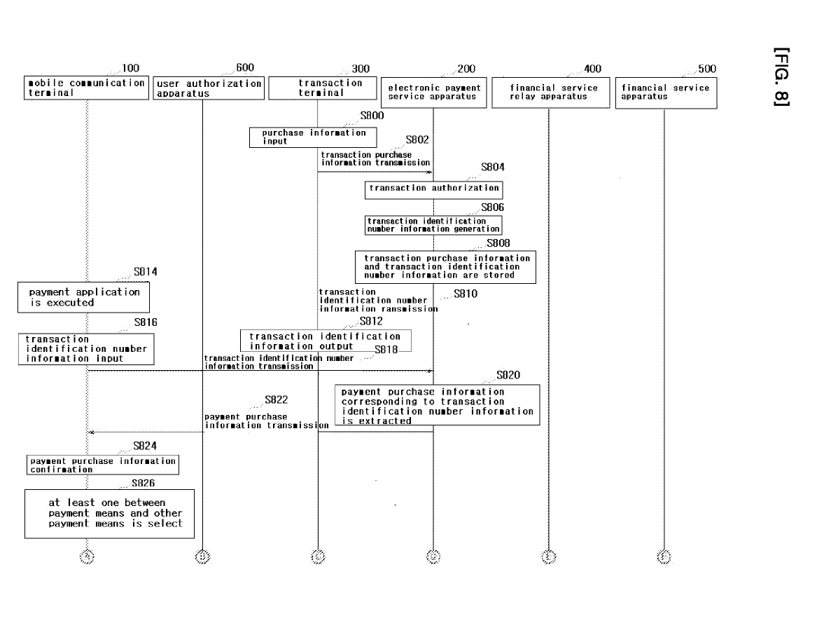

FIG. 7 is a view for explaining an electronic payment service method in a transaction terminal according to an embodiment of the present invention.

As shown in FIG. 7, in a step S705, the transaction terminal 300 receives a purchase information. The purchase information might contain at least one among an information of goods which will be paid by the transaction terminal 300, a quantity information of goods and a price information of goods.

In a step S710, the transaction terminal 300 generates a transaction purchase information corresponding to the purchase information and transmits it to the electronic payment service apparatus 200.

In a step S715, the transaction terminal 300 receives a transaction identification number information corresponding to a purchase information from the electronic payment service apparatus 200.

In a step S720, the transaction terminal 300 outputs a received transaction identification number.

Here, the output of the transaction identification number might be either an output which can be recognized by one sense among a visible sense, an audible sense and a tactile sense or an output among a bar code, a QR code, an image, an audio and a braille output or an output of a RF signal.

In a step S725, the transaction terminal 300 receives a payment authorization result information corresponding to a payment information transmitted to the electronic payment service apparatus 200 in the mobile communication terminal 100.

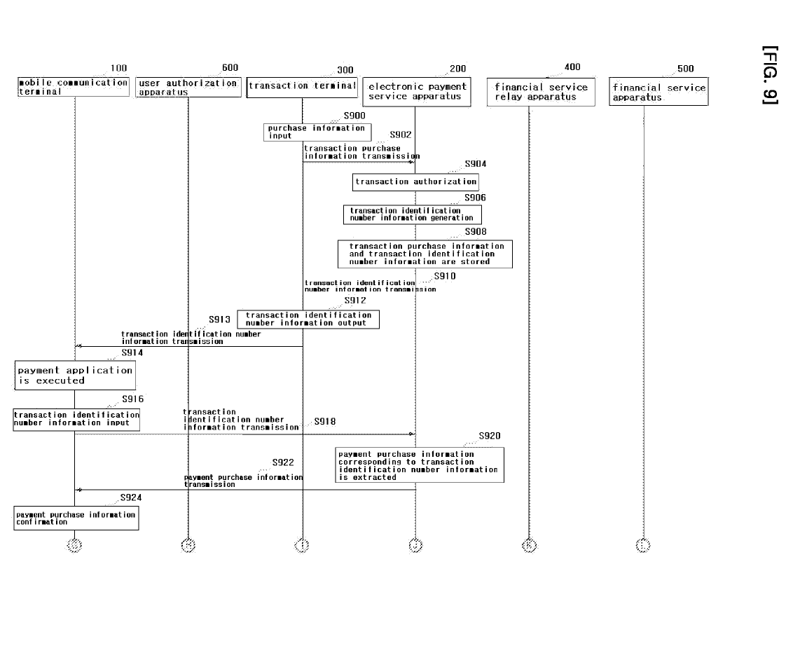

FIGS. 8 and 9 are views for explaining the electronic payment service method using a mobile communication network according to an embodiment of the present invention.

As shown in FIG. 8, in a step S800, the transaction terminal 300 receives a purchase information. The purchase information might be one among an information of good that a user has purchased, a quantity information of goods and a price information of goods.

In a step S802, the transaction terminal 300 transmits a transaction purchase information to the electronic payment service apparatus 200. The transaction purchase information might be a transaction terminal identification information and a contracted shop information in addition to the purchase information inputted into the transaction terminal 300.

In a step S804, the electronic payment service apparatus 200 performs a transaction authorization. The electronic payment service apparatus 200 performs a transaction authorization so as to confirm whether there is a valid contract relationship with at least one between the transaction terminal that has sent the transaction purchase information and the contracted shop along with the electronic payment service apparatus.

In a step S806, the electronic payment service apparatus 200 generates a transaction identification number information. The electronic payment service apparatus 200 generates a transaction identification number information corresponding to the received transaction purchase information.

In a step S808, the electronic payment service apparatus 200 stores a transaction purchase information and a transaction identification number information corresponding to the transaction purchase information into the storing part 250.

In a step S810, the electronic payment service apparatus 200 transmits the transaction identification number information to the transaction terminal 300. Here, the electronic payment service apparatus 200 might transmit the transaction identification number information to the transaction terminal 300 that has sent the transaction purchase information by using the transaction terminal identification number contained in the transaction purchase information. In addition, the electronic payment service apparatus 200 can transmit a transaction identification number information to other transaction terminals that the transaction terminal 300, that has sent the transaction purchase information, has requested.

In a step S812, the transaction terminal 300 outputs a transaction identification number information.

In a step S814, the mobile communication terminal 100 executes a payment application. The payment application is one selected between a payment means and an auxiliary payment means when paying and is an application helps execute the payment by way of guides for the sake of user authorization.

In a step S816, a transaction identification number information is inputted into the mobile communication terminal 100.

In a step S818, the mobile communication terminal 100 transmits a transaction identification number information to the electronic payment service apparatus 200. At this time, the mobile communication terminal 100 can transmit a transaction identification number information to the electronic payment service apparatus 200 via the mobile communication network.

In a step S820, the electronic payment service apparatus 200 extracts a payment purchase information corresponding to the received transaction identification number information. In addition to the payment purchase information, the payment purchase information includes a transaction terminal 300 or an auxiliary payment means information which can be applied to the contracted shop. The auxiliary payment means can be stored in the storing part 250 by the transaction terminal 300 or the contracted shop in the electronic payment service apparatus 200. The auxiliary payment means information might include a purchase information received from the transaction terminal 300.

In a step S822, the electronic payment service apparatus 200 transmits the extracted payment purchase information to the mobile communication terminal 100.

In a step S824, the mobile communication terminal 100 confirms the payment purchase information. The mobile communication terminal 100 outputs via the output part 160 of the mobile communication terminal 100 so as to confirm whether the payment purchase information received from the electronic payment service apparatus 20 matches with an information that the user of the mobile communication terminal 100 wants.

In a step S826, the mobile communication terminal 100 selects at least one between a payment means and an auxiliary payment means. Here, the payment means might be one among a credit card information stored in the mobile communication terminal 100, an account information, a gift card information and a rate payment information of the mobile communication terminal. The user can select a payment means to be used for the sake of payments among the payment means inputted via the input part 110 of the mobile communication terminal 100. The auxiliary payment means is a means to which is adapted at least one between the discount and the saving in the middle of payments. The auxiliary payment means might be a mobile communication company's membership card, a contracted shop's membership card, an OK cash back point, a coupon service, etc. The mobile communication terminal 100 can select a corresponding transaction terminal 300 or an auxiliary payment means which can be adapted to the contracted shop with the aid of the received third transaction purchase information.

As shown in FIG. 9, in a step 828, the mobile communication terminal 100 generates a user authorization information. The mobile communication terminal 100 generates a user authorization information so as to confirm whether the user is proper for the sake of payments.

In a step S830, the mobile communication terminal 100 transmits the user authorization information to the user authorization apparatus 600. Here, the user authorization apparatus 600 is an apparatus for confirming whether the user is proper for the sake of payments. The user authorization apparatus 600 might be separately positioned or might be contained in the electronic payment service apparatus 200 or the financial service apparatus 500.

In a step S832, the user authorization apparatus 60 executes a user authorization. The user authorization apparatus 600 performs a user authorization using the received user authorization information.

In a step S834, the user authorization apparatus 600 transmits a user authorization result information to the mobile communication terminal 100. The user authorization apparatus 600 performs a user authorization using the received user authorization information and transmits a result of it to the mobile communication terminal 100.

In a step S836, the mobile communication terminal 100 receives a user authorization result information. The mobile communication terminal 10 can output via the output part 160 whether or not the user can perform payment by confirming the user authorization result received from the user authorization apparatus 600.

In a step S838, the mobile communication terminal 100 generates a payment information. The mobile communication terminal 100 generates a payment information including at least one among a third transaction purchase information, an authorization information and a mobile communication information if it is confirmed that the user is proper for the sake of payments.

In a step S840, the mobile communication terminal 100 transmits a payment information to the electronic payment service apparatus 200.

In a step S842, the electronic payment service apparatus 200 generates a payment authorization information. The electronic payment service apparatus 200 generates a payment authorization information using the payment information received from the mobile communication terminal 100. The payment authorization information is an information for requesting a payment authorization to the financial service apparatus 500 using a payment information. For example, the payment authorization information includes an information on the electronic payment service apparatus 200 in addition to the payment information.

In a step S844, the electronic payment service apparatus 200 transmits the generated payment authorization information to the financial service relay apparatus 400. The financial service relay apparatus 400 serves to relay the financial service apparatus 500 with the contracted shop. For example, the financial service relay apparatus 400 might be a server of VAN (Value-Added Network) company.

In a step S846, the financial service relay apparatus 400 requests a payment authorization to the financial service apparatus 500. The financial service relay apparatus 400 request a payment authorization by transmitting the payment authorization information received from the electronic payment service apparatus 200 to the financial service apparatus 500.

Here, the step that the financial service relay apparatus 400 requests a payment to the financial service apparatus 500 using the payment authorization information received form the electronic payment service apparatus 200 might be omitted. In other words, the electronic payment service apparatus 200 might directly transmit the payment authorization information generated in the step S842 to the financial service apparatus 500. So, if the step S844 is omitted, in a step S846, the electronic payment service apparatus 200 transmits a payment authorization information to the financial service apparatus 500, the payment authorization is executed.

In a step S848, the financial service apparatus 500 performs a payment authorization. The financial service apparatus 500 performs a payment authorization using the received payment authorization information. The financial service apparatus 500 generates a payment authorization result information which is a result of the payment authorization.

In a step S850, the financial service apparatus 500 transmits a payment authorization result information to the financial service relay apparatus 400.

In a step S852, the financial service relay apparatus 400 transmits a payment authorization result information to the electronic payment service apparatus 200.

If the relay step of the financial service relay apparatus 400 or the financial service relay apparatus 400 is omitted, in a step S850, the financial service apparatus 500 can directly transmit the payment authorization result to the electronic payment service apparatus 200. The electronic payment service apparatus 200 which has received the payment authorization result information performs the step S854.

In a step S854, the electronic payment service apparatus 200 transmits the received payment authorization result information to the transaction terminal 300.

In a step S856, the transaction terminal 300 outputs the received payment authorization result.

In a step S858, the electronic payment service apparatus 200 transmits the received payment authorization result information to the mobile communication terminal 100.

In a step S860, the mobile communication terminal 100 outputs the received payment authorization result information.

Here, the steps S854 and 858 can be concurrently performed.

According to the embodiments of the present invention, the mobile communication terminal 100 and the financial service apparatus 500 can communicate with each other all data by way of the asymmetric encoding. In other words, the mobile communication terminal 100 and the financial service apparatus 500 can ensure the end to end security by way of an asymmetrical encoding. So, the credit information of the user using the mobile communication terminal 100 is not exposed since it is processed by way of the mobile communication terminal 100 and the financial service apparatus 500.

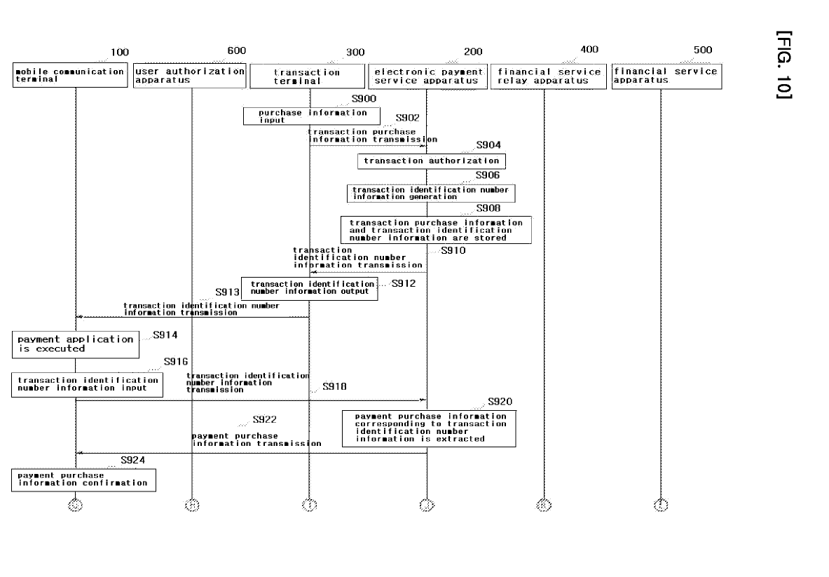

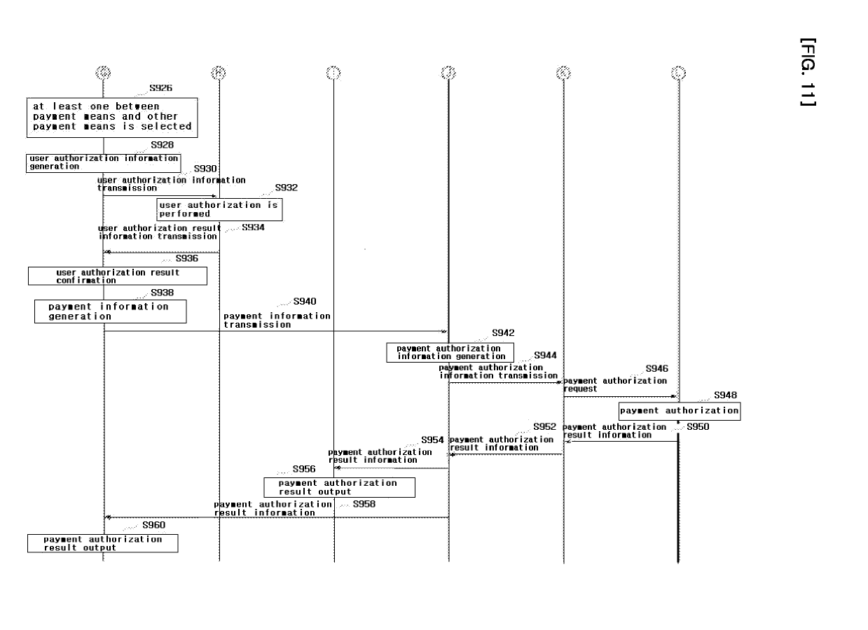

FIGS. 10 and 11 are views for explaining an electronic payment service method using a mobile communication network according to another embodiment of the present invention.

As shown in FIG. 10, a purchase information is inputted the transaction terminal 300 in the step S900.

In a step S902, the transaction terminal 300 transmits a transaction purchase information to the electronic payment service apparatus 200.

In a step S904, the electronic payment service apparatus 200 performs a transaction authorization.

In a step S906, the electronic payment service apparatus 200 generates a transaction identification number information.

In a step S908, the electronic payment service apparatus 200 stores a transaction purchase information and a transaction identification number information.

In a step S910, the electronic payment service apparatus 200 transmits a transaction identification number information to the transaction terminal 300.

In a step S912, the transaction terminal 300 outputs a transaction identification number information.

In a step S913, the transaction terminal 300 transmits a transaction identification number information to the mobile communication terminal 100. The transaction terminal 300 can transmit to the mobile communication terminal 100 by way of a wireless communication method using NFC (Near Field Communication), wifi direct, blue tooth, zigbee, etc. as well as a mobile communication network.

In a step S914, the mobile communication terminal 100 executes a payment application. The payment application can be executed when the mobile communication terminal 100 outputs a transaction identification number information to the transaction terminal 300 or the payment application can be automatically performed when a transaction identification number information that the mobile communication terminal 100 has received is received or a transaction identification number is received from the transaction terminal 100.

In a step S916, a transaction identification number information is inputted into the mobile communication terminal 100. In the mobile communication terminal 100, the transaction identification number information received from the transaction terminal 300 is inputted into the transaction identification number information input section of the executed payment application. For example, a transaction identification number information can be directly inputted into the mobile communication terminal 100 by way of the input part 110 or the mobile communication terminal 100 might receive a transaction identification number information by way of a mobile communication network or a local area wireless communication from the transaction terminal 300. At this time, when the mobile communication terminal 100 receives a transaction identification information, the payment application is executed, and the automatically received transaction identification number information is inputted into the transaction identification number information input section.

In a step S918, the mobile communication terminal 100 transmits a transaction identification number information to the electronic payment service apparatus 200.

In a step S920, the electronic payment service apparatus 200 extracts a payment purchase information corresponding to the received transaction identification number information.

In a step S922, the electronic payment service apparatus 200 transmits the extracted payment purchase information to the mobile communication terminal 100.

In a step S924, the mobile communication terminal 100 confirms the payment purchase information.

As shown in FIG. 11, in a step S926, the mobile communication terminal 100 selects at least one between a payment means and an auxiliary payment means.

In a step S928, the mobile communication terminal 100 generates a user authorization information.

In a step S930, the mobile communication terminal 100 transmits a user authorization information to the user authorization apparatus 600.

In a step S932, the user authorization apparatus 600 performs a user authorization.

In a step S934, the user authorization apparatus 600 transmits a user authorization result information to the mobile communication terminal 100.

In a step S936, the mobile communication terminal 100 receives a user authorization result information.

In a step S938, the mobile communication terminal 100 generates a payment information.

In a step S940, the mobile communication terminal 100 transmits the generated payment information to the electronic payment service apparatus 200.

In a step S942, the electronic payment service apparatus 200 generates a payment authorization information.

In a step S944, the electronic payment service apparatus 200 transmits the generated payment authorization information to the financial service relay apparatus 400.

In a step S946, the financial service relay apparatus 400 requests a payment authorization to the financial service apparatus 500.

In a step S948, the financial service apparatus performs a payment authorization.

In a step S950, the financial service apparatus 500 transmits a payment authorization result information to the financial service relay apparatus 400.

In a step S952, the financial service relay apparatus 400 transmits a payment authorization result information to the electronic payment service apparatus 200.

In a step S954, the electronic payment service apparatus 200 transmits the received payment authorization result information to the transaction terminal 300.

In a step S956, the transaction terminal 300 outputs the received payment authorization result information.

In a step S958, the electronic payment service apparatus 200 transmits the received payment authorization result information to the mobile communication terminal 100.

In a step S960, the mobile communication terminal 100 outputs the received payment authorization result information.

Here, the steps S954 and 958 can be concurrently performed and it is obvious that at least one step between them can be performed.

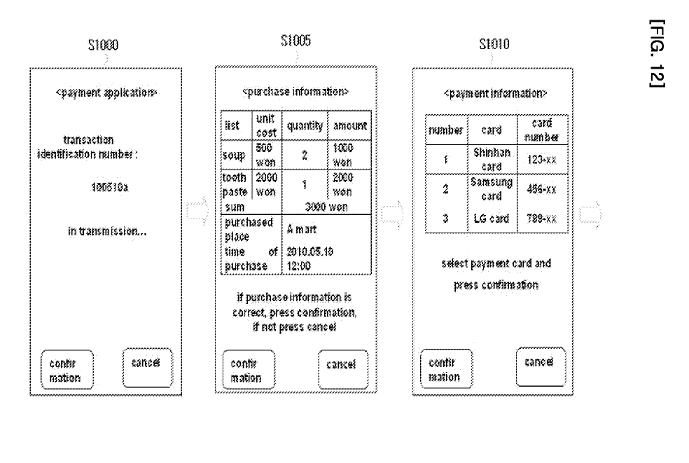

FIGS. 12 to 15 are views illustrating the examples of the electronic payment service method using a mobile communication terminal according to an embodiment of the present invention.

As shown in FIG. 12, in a step S1000, the mobile communication terminal 100 inputs a transaction identification number information in the transaction identification number information input section and transmits to the electronic payment service apparatus 200. The transaction identification number information features in that the transaction identification number information outputted via the output part of the transaction terminal 300 can be inputted by way of the input part 110 of the mobile communication terminal 100 or the transaction identification number can be inputted by receiving it from the transaction terminal 300 by way of the communication part 150 in a wireless way.

In a step S1005, the mobile communication terminal 100 receives a transaction purchase information from the electronic payment service apparatus 200. The mobile communication terminal 100 outputs the received transaction purchase information via the output part 160.

In a step S1010, the mobile communication terminal 100 selects a payment means. A user can select a payment means among the payment means stored in the mobile communication terminal 100. At this time, only the payment means which can be used in the contracted shop among the payment means stored in the mobile communication terminal 100 can be outputted in an active state via the output part 160 of the mobile communication terminal 100. In other words, the user can select a certain payment means among the activated payment means on the output part of the mobile communication terminal 100, so the payment failure can be reduced.

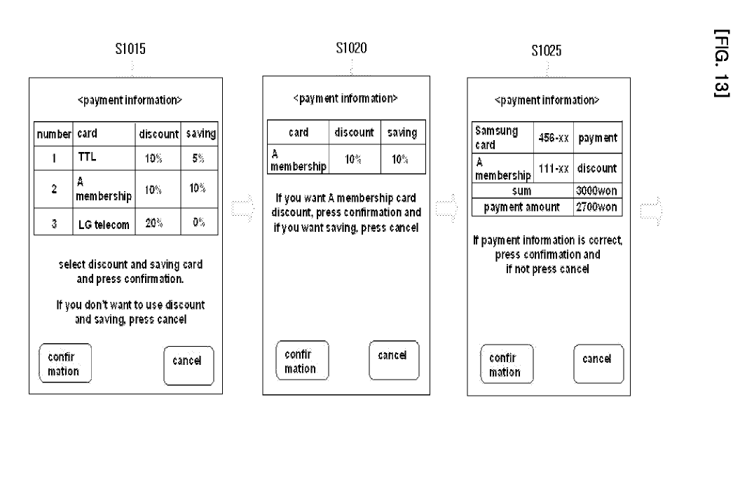

As shown in FIG. 13, in a step S1015, the mobile communication terminal 100 selects an auxiliary payment means. The user can select a desired payment means among the payment means stored in the mobile communication terminal 100. At this time, the auxiliary payment means can be outputted like the payment means in such a way that only the auxiliary payment means which can be used in the contracted shop can be outputted via the mobile communication terminal 100 in an active state.

In a step S1020, the mobile communication terminal 100 selects an auxiliary payment to be adapted by way of the selected auxiliary payment means. For example, in case of the membership card “A” selected by the user, the discount or point saving can be adapted in the contracted shop. At this time, with the membership card “A”, the user can select the discount or the point saving.

In a step S1025, the mobile communication terminal 100 displays a payment amount when the payment means and the auxiliary payment means that the user has selected are adapted.

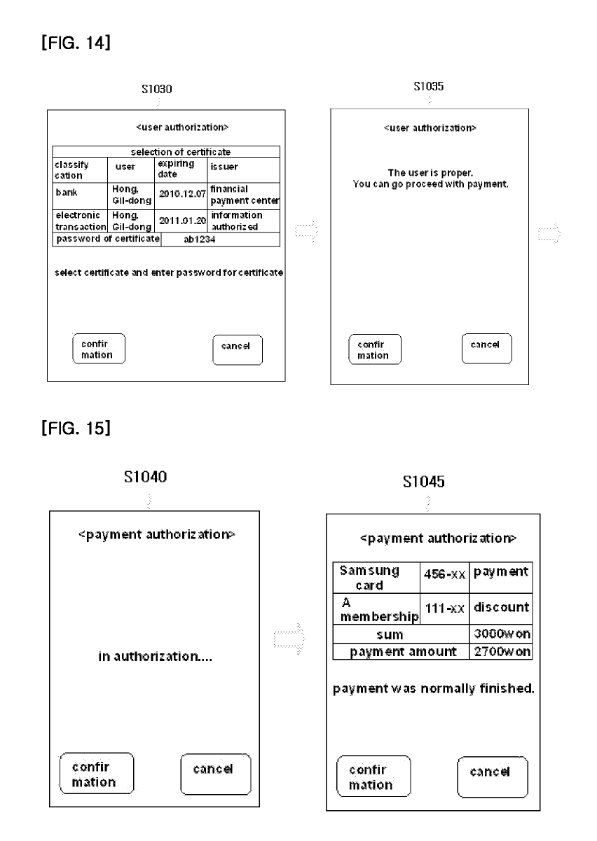

As shown in FIG. 14, in a step S1030, the mobile communication terminal 100 performs a user authorization. The user authorization means to be used for the sake of a user authorization is selected among a plurality of user authorization means stored in the mobile communication terminal 100. The user authorization can be performed as the user authorization means information based on the user authorization means selected by way of the mobile communication terminal 100 is transmitted to the user authorization apparatus 600.

In a step S1035, the mobile communication terminal 100 outputs a user authorization result. It is possible to confirm whether or not the user is proper for the sake of a payment by way of the mobile communication terminal 100 based on the user authorization result. If the user is not proper for the sake of the payments as a result of the user authorization, the payment procedure no longer continues or the routine is performed again from the step selecting the payment means or the auxiliary payment means.

As shown in FIG. 15, in a step S1040, the mobile communication terminal 100 performs a payment after the user authorization. The payment is requested using the payment means or the auxiliary payment means which was selected in the previous steps.

In a step S1045, the mobile communication terminal 100 receives a result of the payment authorization and outputs it. The mobile communication terminal 100 can confirm whether the payment is normally finished or not.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. An electronic payment service apparatus performing a payment using a mobile communication network, comprising:
a transaction authorization part which receives a transaction purchase information from a transaction terminal and authorizes the transaction terminal;
a transaction identification number information generation part which generates a transaction identification number information corresponding to the transaction purchase information received from the transaction terminal; and
a payment authorization information generation part which transmits the transaction identification number information to the transaction terminal and receives a payment information corresponding to the transaction identification number information from the mobile communication terminal and generates a payment authorization information corresponding to the payment information.

2. An electronic payment service apparatus performing a payment using a mobile communication network according to claim 1, wherein the transaction purchase information includes at least one among a goods information, a quantity information of goods, a price information of goods, a transaction terminal identification information and a contracted shop information.

3. An electronic payment service apparatus performing a payment using a mobile communication network according to claim 2, further comprising:
a storing part which stores at least one among the transaction purchase information, the transaction identification number information and the auxiliary payment information.

4. An electronic payment service apparatus performing a payment using a mobile communication network according to claim 2, wherein the transaction authorization part authorizes the transaction terminal using the transaction terminal identification information or the contracted shop information.

5. An electronic payment service apparatus performing a payment using a mobile communication network according to claim 1, wherein the transaction identification number information is generated whenever the transaction purchase information is received from the transaction terminal.

6. An electronic payment service apparatus performing a payment using a mobile communication network according to claim 1, wherein the payment information and the payment authorization information include at least one among the information of the mobile communication terminal, a payment amount information, a user authorization information, a payment means information and an auxiliary payment means information.

7. An electronic payment service method performing a payment using a mobile communication network in an electronic payment service apparatus, comprising:
a step in which a transaction purchase information is received from a transaction terminal, and the transaction terminal is authorized;
a step in which a transaction identification number information corresponding to the transaction purchase information received from the transaction terminal is generated;
a step in which the transaction identification number information is transmitted to the transaction terminal, and the transaction identification number information is received from the mobile communication terminal;
a step in which at least one between the transaction purchase information corresponding to the transaction identification number information received from the mobile communication terminal and an auxiliary payment information is transmitted to the mobile communication terminal;
a step in which the auxiliary payment information is an information on the auxiliary payment including a discount service or point service corresponding to the transaction terminal; and
a step in which a payment information including at least one among the transaction identification number information, a payment means information and an auxiliary payment means information is received from the mobile communication terminal.

8. An electronic payment service apparatus performing a payment using a mobile communication network according to claim 7, further comprising:
a step in which a payment authorization information corresponding to the payment information is generated;
a step in which the payment authorization information is transmitted to a financial service apparatus;
a step in which a payment authorization result information on the payment authorization information is received from the financial service apparatus; and
a step in which the payment authorization result information is transmitted to at least one between the transaction terminal and the mobile communication terminal.

9. An electronic payment service apparatus performing a payment using a mobile communication network according to claim 7, further comprising:
a step in which the transaction purchase information and the transaction identification number information are stored in the storing part.

10. A mobile communication terminal executing an electronic payment service apparatus and an electronic payment service method, comprising:
an input part for inputting a transaction identification number information into the transaction purchase information;
a communication part for transmitting the transaction identification number information to the electronic payment service apparatus and receiving a payment purchase information from the electronic payment service apparatus;
a generation part for generating a payment information including at least one between the payment means corresponding to the payment purchase information and the auxiliary payment means; and
a control part for executing a payment application for generating the payment information.

11. A mobile communication terminal executing an electronic payment service apparatus and an electronic payment service method according to claim 10, wherein into the input part is inputted the transaction identification number information using a least one among a key input method, an audio input method, a video input method, and a wireless communication input method.

12. A mobile communication terminal executing an electronic payment service apparatus and an electronic payment service method according to claim 11, wherein the image input method is performed by one among a bar code, a QR code and an image.

13. A mobile communication terminal executing an electronic payment service apparatus and an electronic payment service method according to claim 11, wherein the wireless communication input method is directed to inputting using a wireless communication method among NFC (Near Field Communication), wifi direct, blue tooth and zigbee.

14. A mobile communication terminal executing an electronic payment service apparatus and an electronic payment service method according to claim 10, wherein the auxiliary payment means information is at least one between a coupon information and a point information.

15. A mobile communication terminal executing an electronic payment service apparatus and an electronic payment service method according to claim 10, wherein the control part executes the payment application when the transaction identification number information is inputted.

16. An electronic payment service method executed on an electronic payment service apparatus on a mobile communication terminal, comprising:
a step in which a transaction identification information corresponding to a transaction purchase information is inputted;
a step in which the transaction identification number information is transmitted to the electronic payment service apparatus, and the payment purchase information is received from the electronic payment service apparatus;
a step in which a payment information including at least one between a payment means corresponding to the payment purchase information and an auxiliary payment means is generated and transmitted to the electronic payment service apparatus; and
a step in which a payment authorization result information corresponding to the payment information is received from the electronic payment service apparatus.

17. An electronic payment service method executed on an electronic payment service apparatus on a mobile communication terminal according to claim 16, wherein the transaction purchase information includes at least one among a goods information which will be paid for by way of the mobile communication terminal, a quantity information of goods, a price information of goods, a transaction terminal identification information and a contracted shop information.

18. An electronic payment service method executed on an electronic payment service apparatus on a mobile communication terminal according to claim 16, wherein the transaction identification number is inputted as it is outputted from the transaction terminal which transmits the transaction purchase information to the electronic payment service apparatus or is inputted as it is received from the other mobile communication terminal.

19. An electronic payment service method executed on an electronic payment service apparatus on a mobile communication terminal according to claim 16, wherein the payment information includes at least one among a mobile communication terminal identification information, a transaction identification number information and a user authorization information.

20. An electronic payment service method executed on an electronic payment service apparatus on a mobile communication terminal according to claim 16, further comprising:
a step for executing a payment application for the sake of the payment information generation after the step in which the transaction identification number information is inputted is finished.

21. An electronic payment service method executed on an electronic payment service apparatus on a mobile communication terminal according to claim 16, wherein the step in which a payment information including at least one between the payment means corresponding to the payment purchase information and the auxiliary payment means is generated and is transmitted to the electronic payment service apparatus comprises:
a step in which to the user authorization apparatus is transmitted at least one among a certificate information for the sake of a user authorization with respect to the payment information, an IC (Integrated Circuit) information, an identification information corresponding to the mobile communication terminal, an authorization number information received from the user authorization apparatus, an ID information and a password information.

22. A transaction terminal executing an electronic payment service, comprising:
an input part for inputting a purchase information;
a communication part for generating a transaction purchase information corresponding to the purchase information and transmitting to the electronic payment service apparatus and receiving a transaction identification number corresponding to the transaction purchase information; and
an output part for outputting the transaction identification number.

23. A transaction terminal executing an electronic payment service according to claim 22, wherein the transaction terminal is one among a computer, CE (Consumer Electronics) device, a cellular phone, a smart phone, a communication type navigation device, a laptop computer, a net book computer, a smart pad and a PDA (Portable Digital Assistant).

24. A transaction terminal executing an electronic payment service according to claim 22, wherein the output part is at least one among a display, a speaker, a braille output device and a local area wireless communication module.

25. A transaction terminal executing an electronic payment service according to claim 22, wherein the local area wireless communication module is at least one among NFC (Near Field Communication), wife direct, blue tooth and a zigbee communication module.

26. A transaction terminal executing an electronic payment service according to claim 22, wherein the output part is configured to output at least one among a barcode, a QR code, an image, a voice and a wireless communication signal.

27. An electronic payment service method executed on an electronic payment service apparatus in a transaction terminal, comprising:
a step for inputting a purchase information and generating a transaction purchase information corresponding to the purchase information;
a step for transmitting the transaction purchase information to the electronic payment service apparatus;
a step for receiving a transaction identification number corresponding to the transaction purchase information from the electronic payment service apparatus; and
a step for outputting the transaction identification number.

28. An electronic payment service method executed on an electronic payment service apparatus in a transaction terminal according to claim 27, wherein the purchase information includes at least one among a goods information, a quantity information of goods and a price information of goods.

29. An electronic payment service method executed on an electronic payment service apparatus in a transaction terminal according to claim 27, further comprising:
a step for receiving a payment authorization result information corresponding to the transaction identification number from the electronic payment service apparatus.

30. An electronic payment service method executed on an electronic payment service apparatus in a transaction terminal according to claim 29, wherein in the step for receiving a payment authorization result information, the payment authorization result information is encoded by way of an asymmetrical key encoding and is received.

31. An electronic payment service method executed on an electronic payment service apparatus in a transaction terminal according to claim 27, wherein in the step for outputting the transaction identification number, the transaction identification number is outputted in a form selected from a barcode, a QR code, an image, a voice, a braille output and a RF (Radio Frequency) signal.

32. An electronic payment service method executed on an electronic payment service apparatus in a transaction terminal according to claim 31, wherein the wireless communication signal is at least one among NFC (Near Field Communication), wifi direct, blue tooth and a zigbee communication signal.
